(19) United States
(12) Patent Application Publication
(10) Pub. No.: US 2026/0256109 A1
(43) Pub. Date: Sep. 3, 2026

(54) CAT LITTER AND ITS PREPARATION METHOD

(71) Applicant: OGAWA ZHIZAO NEW MATERIAL PROCESSING (HUAI'AN) CO., LTD., Suzhou City (CN)

(72) Inventors: HONGWU NIU, Suzhou City (CN); DONGFANG GE, Suzhou City (CN)

(73) Assignee: OGAWA ZHIZAO NEW MATERIAL PROCESSING (HUAI'AN) CO., LTD., Suzhou City (CN)

(21) Appl. No.: 19/658,679

(22) Filed: Apr. 26, 2026

Related U.S. Application Data
(63) Continuation of application No. PCT/CN2023/136022, filed on Dec. 4, 2023.

(30) Foreign Application Priority Data
Oct. 26, 2023 (CN) 202311402821.3

(51) Int. Cl. A01K 1/015

(52) U.S. Cl. CPC A01K 1/0155; A01K 1/0154

(57) ABSTRACT

Disclosed is a cat litter, including the following raw material compositions in weight parts: 40-60 parts of bamboo extract, 10-20 parts of soybean residue powder, 5-10 parts of sweet potato residue powder, 4-8 parts of pine sawdust, 30-50 parts of bentonite, 5-8 parts of diatomaceous earth, 5-8 parts of volcanic rock particles, 4-6 parts of perlite powder, 0.5-1.5 parts of anthocyanins, and 4-6 parts of binder. The present disclosure also discloses a method for preparing cat litter, including the following steps: S1. Preparation of raw materials; S2. Preliminary mixing of raw materials; S3. Grinding; S4. Solution preparation; S5. Secondary mixing; S6. Granulation; S7. Drying. The present disclosure adds bamboo extract to make the raw materials green and healthy, increasing safety of use. When discarded, it can be directly buried in the ground as a soil nutrient, which is environmentally friendly, biodegradable, safe and pollution-free.

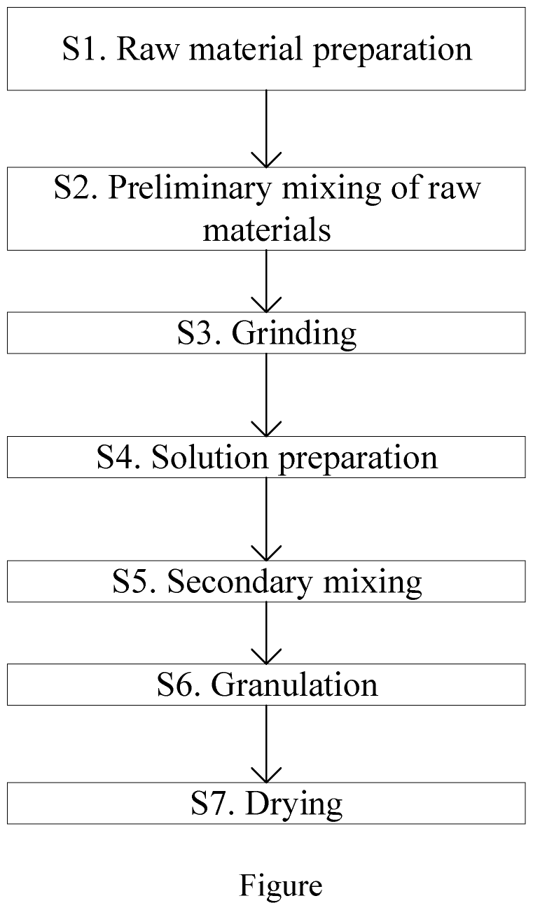

### CROSS-REFERENCE

This application is a continuation of International Application No. PCT/CN2023/136022 with a filling date of Dec. 4, 2023, designating the United States, now pending, which further claims to the benefit of priority from Chinese Application No. 202311402821.3 with a filing date of Oct. 26, 2023. The content of the aforementioned applications, including any intervening amendments thereto, are incorporated herein by reference.

### TECHNICAL FIELD

The present disclosure relates to the technical field of cat litter, in particular to a cat litter and its preparation method.

### BACKGROUND

Cat litter is a substance used by pet owners to bury feces and urine of cats. It has good water absorption and is usually used together with a litter box. Pour an appropriate amount of litter into the litter box, and a trained cat will walk into the litter box to defecate when it needs to excrete. Generally, cat litter is made by grinding paper pulp into small particles to simulate sand and provide water absorption. There are also particles that use physical desiccants such as silica gel. Generally, chemical products such as antibacterial agents, deodorizers, and preservatives are added to cat litter. When cat litter encounters water, it will condense into a block, making it easier for pet owners to clean their cat's feces and urine, thereby reducing pollution to the surrounding space.

The Xiaomi plant-based cat litter disclosed in patent application with the publication number CN114982646A, it uses plant-based raw materials, has no pollution or irritating odor, is easily soluble in water, and can flush toilets. The natural plant enzymes added to cat litter can instantly decompose the ammonia absorbed by the litter. The Xiaomi plant-based cat litter has a sheet-like or granular structure with a diameter of less than 3 mm, when cats step on it, the sensation is close to natural sand and does not prick their feet. It has been tested and found to be easy for cats to accept without an adaptation period. However, it does not solve the problems of existing cat litter and its preparation methods: the high softness of cat litter reduces the comfort of cats, the use of more natural materials increases production costs, and it is not convenient for detecting the pH of cat urine, resulting in the inability to timely understand the physical health status of cats. Therefore, the present disclosure proposes a cat litter and its preparation method.

### SUMMARY

The objective of the present disclosure is to provide a cat litter and its preparation method to solve the problems raised in the background mentioned above.

In order to achieve the above objective, the present disclosure provides a technical solution as follows: a cat litter, including the following raw material compositions in weight parts: 40-60 parts of bamboo extract, 10-20 parts of soybean residue powder, 5-10 parts of sweet potato residue powder, 4-8 parts of pine sawdust, 30-50 parts of bentonite, 5-8 parts of diatomaceous earth, 5-8 parts of volcanic rock particles, 4-6 parts of perlite powder, 0.5-1.5 parts of anthocyanin, and 4-6 parts of binder.

Preferably, the cat litter includes the following raw material compositions in weight parts: 50 parts of bamboo extract, 15 parts of soybean residue powder, 8 parts of sweet potato residue powder, 6 parts of pine sawdust, 40 parts of bentonite, 7 parts of diatomaceous earth, 7 parts of volcanic rock particles, 5 parts of perlite powder, 1 part of anthocyanin, and 5 parts of binder.

Preferably, the binder includes one or more of guar gum, locust bean gum, and sodium carboxymethyl starch.

A method for preparing cat litter, including the following steps:
S1, raw material preparation: preparing raw materials according to the following weight parts: 40-60 parts of bamboo extract, 10-20 parts of soybean residue powder, 5-10 parts of sweet potato residue powder, 4-8 parts of pine sawdust, 30-50 parts of bentonite, 5-8 parts of diatomaceous earth, 5-8 parts of volcanic rock particles, 4-6 parts of perlite powder, 0.5-1.5 parts of anthocyanin, and 4-6 parts of binder;
S2, preliminary mixing of raw materials: mixing the bamboo extract, the soybean residue powder, the sweet potato residue powder, and the pine sawdust evenly to obtain a first mixed powder;
S3, grinding: placing the bentonite, the diatomaceous earth, the volcanic rock particles, and the perlite powder into a ball mill, then grinding and mixing to obtain a second mixed powder;
S4, solution preparation: mixing the anthocyanin with water thoroughly to form a mixed solution;
S5, secondary mixing: thoroughly mixing the first mixed powder with the mixed solution and adding the binder at the same time, then adding the second mixed powder for thorough mixing, and adding the binder to prepare a pasty mass;
S6, granulation: putting the pasty mass into a granulator to perform granulation to form mixed particles;
S7. drying: drying the mixed particles, and then cooling the mixed particles after drying to obtain a finished cat litter product.

Preferably, the method for preparing the bamboo extract includes:
S101, cleaning bamboo branches, then drying the bamboo branches, and then crush the bamboo branches after drying with a grinder to obtain crushed bamboo material;
S102, soaking the crushed bamboo material in NaOH solution for 1-3 hour, after soaking is complete, adding an acid solution to adjust a pH value to obtain a bamboo aqueous solution, wherein the pH value of the bamboo aqueous solution is 5.6-6.6;
S103, adding ethyl acetate and ether to the bamboo aqueous solution, and applying distillation process to obtain the bamboo extract.

Preferably, the method for preparing the soybean residue powder includes:
S201, taking soybean residue and wash the soybean residue for multiple times, then placing the soybean residue after washing in a dryer to perform drying;
S202, placing the soybean residue after drying in a crushing device to crush, then sieving the soybean residue after crushing to obtain primary soybean residue powder;
S203, adding an appropriate amount of distilled water to the primary soybean residue powder for wetting, then adjusting the pH value, and then sending the primary soybean residue powder after PH adjustment to the dryer for further drying to obtain a finished soybean residue powder.

Preferably, the drying temperature of the dryer in S203 is 120° C.-160° C., the drying time is 30-60 minutes, and the moisture content in the soybean residue powder is dried to 6-10%, wherein the soybean residue after crushing in S202 is sieved through a 70-90 mesh sieve.

Preferably, the preparation method of the sweet potato residue powder is the same as that of the soybean residue powder.

Preferably, the diameter of the particles of the cat litter is 3-5 mm, and the length of the particles of the cat litter is 0.4-1.2 cm.

Compared with the prior art, the advantageous effects of the present disclosure are shown as below:

(1) The present disclosure adds bamboo extract to make the raw materials green and healthy, increasing safety of use. At the same time, adding soybean residue powder, sweet potato residue powder, and pine sawdust can not only reduce material costs, but also increase softness and strong water absorption. When discarded, it can be directly buried in the ground as soil nutrients.

It is environmentally friendly and biodegradable, safe and pollution-free, with renewable raw materials, thereby increasing resource utilization efficiency.

(2) The cat litter in the present disclosure is made by mixing anthocyanins with other raw materials in proportion, granulation, and drying. By adding anthocyanins, the anthocyanins can change color in response to the different pH levels of pet excrement, thereby determining whether the pet is healthy. For example, when a pet consumes excessive amounts of meat, its excrement becomes acidic, and the anthocyanin color changes to red; when a pet consumes excessive amounts of vegetables, its excrement becomes alkaline, and the anthocyanin color changes to green, in severe cases, it may turn yellow; under normal conditions, the anthocyanin does not change color. This phenomenon enables real-time monitoring of the cat excrement pH, allowing pet owners to promptly understand the health status of their cat.

(3) The addition of diatomaceous earth to the raw materials of the present disclosure can enhance the odor adsorption capacity of cat litter, effectively improving its deodorizing performance. By adding volcanic rock particles and utilizing their resistance to mold, the cat litter can inhibit the growth of mold in humid environments and has high antibacterial properties. In addition, volcanic rock particles also have high thermal insulation effects, thereby improving the quality of cat litter use. Moreover, by mixing anthocyanins with pine sawdust into the gaps of volcanic rock particles, effective protective effects are formed on anthocyanins, extending their effective use period. Even if cat litters are left in the air for a long time, they will not undergo chemical reactions and cause natural failure, thus extending the service life of cat litter.

### BRIEF DESCRIPTION OF THE DRAWING

The FIGURE is a flowchart of the present disclosure.

### DETAILED DESCRIPTION OF THE EMBODIMENTS

The following will provide a clear and complete description of the technical solution in the embodiments of the present disclosure in conjunction with the accompanying drawings. Obviously, the described embodiments are only a part of the embodiments of the present disclosure, not all of them. Based on the embodiments of the present disclosure, all other embodiments obtained by ordinary skilled persons in the art without creative labor are within the scope of the present disclosure.

### Embodiment 1

Please refer to the FIGURE. The present disclosure provides a technical solution: a cat litter including the following raw material compositions in weight parts: 40 parts of bamboo extract, 10 parts of soybean residue powder, 5 parts of sweet potato residue powder, 4 parts of pine sawdust, 30 parts of bentonite, 5 parts of diatomaceous earth, 5 parts of volcanic rock particles, 4 parts of perlite powder, 0.5 parts of anthocyanin, and 4 parts of binder.

In this embodiment, it is preferred that the adhesive includes guar gum.

A method for preparing cat litter, including the following steps:
S1. Raw material preparation: Prepare raw materials according to the following weight parts: 40 parts of bamboo extract, 10 parts of soybean residue powder, 5 parts of sweet potato residue powder, 4 parts of pine sawdust, 30 parts of bentonite, 5 parts of diatomaceous earth, 5 parts of volcanic rock particles, 4 parts of perlite powder, 0.5 parts of anthocyanin, and 4 parts of binder;
S2. Preliminary mixing of raw materials: Mix the bamboo extract, the soybean residue powder, the sweet potato residue powder, and the pine sawdust evenly to obtain a first mixed powder;
S3. Grinding: Place the bentonite, the diatomaceous earth, the volcanic rock particles, and the perlite powder into a ball mill to perform grinding and mixing to obtain a second mixed powder;
S4. Solution preparation: Mix anthocyanin with water thoroughly to form a mixed solution;
S5. Secondary mixing: thoroughly mix the first mixed powder with the mixed solution and add a binder at the same time, then add the second mixed powder for thorough mixing, and add the binder to prepare a pasty mass;
S6. Granulation: put the pasty mass into a granulator for granulation, forming mixed particles;
S7. Drying: dry the mixed particles, and then cool the dried mixed particles to obtain the finished cat litter product.

Preferably, in this embodiment, the method for preparing the bamboo extract includes:
S101. Clean bamboo branches, then dry the bamboo branches, and then crush them with a grinder to obtain crushed bamboo material;
S102. Soak the crushed bamboo material in NaOH solution for 1 hour. After soaking is complete, add an acid solution to adjust the pH value to obtain a bamboo aqueous solution. The pH value of the bamboo aqueous solution is 5.6;
S103. Add ethyl acetate and ether to the bamboo aqueous solution, and use distillation process to obtain the bamboo extract.

In this embodiment, it is preferred that the method for preparing soybean residue powder includes:
S201. Take the soybean residue and wash it multiple times, then place the washed soybean residue in a dryer for drying;
S202. Place the dried soybean residue in a crushing device and crush it, then sieve the crushed soybean residue to obtain primary soybean residue powder;
S203. Add an appropriate amount of distilled water to the primary soybean residue powder to wet it, then adjust the pH value, and send the primary soybean residue powder after PH adjustment to the dryer for further drying to obtain the finished soybean residue powder.

In this embodiment, it is preferred that the drying temperature of the dryer in S203 is 120° C., the drying time is 30 minutes, and the moisture content in the soybean residue powder is dried to 6%. The crushed soybean residue in S202 is sieved through a 70 mesh sieve.

In this embodiment, it is preferred that the preparation method of the sweet potato residue powder is the same as that of the soybean residue powder.

In this embodiment, it is preferred that the diameter of particles of the cat litter is 3 mm and the length of particles of the cat litter is 0.4 cm.

### Embodiment 2

Please refer to the FIGURE. The present disclosure provides a technical solution: a cat litter including the following raw material compositions in weight parts: 60 parts of bamboo extract, 20 parts of soybean residue powder, 10 parts of sweet potato residue powder, 8 parts of pine sawdust, 50 parts of bentonite, 8 parts of diatomaceous earth, 8 parts of volcanic rock particles, 6 parts of perlite powder, 1.5 parts of anthocyanin, and 6 parts of binder.

In this embodiment, it is preferred that the adhesive includes locust bean gum.

A method for preparing cat litter, including the following steps:
S1. Raw material preparation: Prepare raw materials according to the following weight parts: 60 parts of bamboo extract, 20 parts of soybean residue powder, 10 parts of sweet potato residue powder, 8 parts of pine sawdust, 50 parts of bentonite, 8 parts of diatomaceous earth, 8 parts of volcanic rock particles, 6 parts of perlite powder, 1.5 parts of anthocyanin, and 6 parts of binder;
S2. Preliminary mixing of raw materials: Mix the bamboo extract, the soybean residue powder, the sweet potato residue powder, and the pine sawdust evenly to obtain a first mixed powder;
S3. Grinding: Place the bentonite, the diatomaceous earth, the volcanic rock particles, and the perlite powder into a ball mill to perform grinding and mixing to obtain a second mixed powder;
S4. Solution preparation: Mix anthocyanin with water thoroughly to form a mixed solution;
S5. Secondary mixing: thoroughly mix the first mixed powder with the mixed solution and add a binder at the same time, then add the second mixed powder for thorough mixing, and add the binder to prepare a pasty mass;
S6. Granulation: put the pasty mass into a granulator for granulation, forming mixed particles;
S7. Drying: dry the mixed particles, and then cool the dried mixed particles to obtain the finished cat litter product.

Preferably, in this embodiment, the method for preparing the bamboo extract includes:
S101. Clean bamboo branches, then dry the bamboo branches, and then crush them with a grinder to obtain crushed bamboo material;
S102. Soak the crushed bamboo material in NaOH solution for 3 hours. After soaking is complete, add an acid solution to adjust the pH value to obtain a bamboo aqueous solution. The pH value of the bamboo aqueous solution is 6.6;
S103. Add ethyl acetate and ether to the bamboo aqueous solution, and use distillation process to obtain the bamboo extract.

In this embodiment, it is preferred that the method for preparing soybean residue powder includes:
S201. Take the soybean residue and wash it multiple times, then place the washed soybean residue in a dryer for drying;
S202. Place the dried soybean residue in a crushing device and crush it, then sieve the crushed soybean residue to obtain primary soybean residue powder;
S203. Add an appropriate amount of distilled water to the primary soybean residue powder to wet it, then adjust the pH value, and send the primary soybean residue powder after PH adjustment to the dryer for further drying to obtain the finished soybean residue powder.

In this embodiment, it is preferred that the drying temperature of the dryer in S203 is 160° C., the drying time is 60 minutes, and the moisture content in the soybean residue powder is dried to 10%. The crushed soybean residue in S202 is sieved through a 90 mesh sieve.

In this embodiment, it is preferred that the preparation method of the sweet potato residue powder is the same as that of the soybean residue powder.

In this embodiment, it is preferred that the diameter of particles of the cat litter is 5 mm and the length of particles of the cat litter is 1.2 cm.

### Embodiment 3

Please refer to the FIGURE. The present disclosure provides a technical solution: a cat litter including the following raw material compositions in weight parts: 50 parts of bamboo extract, 15 parts of soybean residue powder, 7 parts of sweet potato residue powder, 6 parts of pine sawdust, 40 parts of bentonite, 7 parts of diatomaceous earth, 6 parts of volcanic rock particles, 5 parts of perlite powder, 0.8 parts of anthocyanin, and 5 parts of binder.

In this embodiment, it is preferred that the adhesive includes sodium carboxymethyl starch.

A method for preparing cat litter, including the following steps:
S1. Raw material preparation: Prepare raw materials according to the following weight parts: 50 parts of bamboo extract, 15 parts of soybean residue powder, 7 parts of sweet potato residue powder, 6 parts of pine sawdust, 40 parts of bentonite, 7 parts of diatomaceous earth, 6 parts of volcanic rock particles, 5 parts of perlite powder, 0.8 parts of anthocyanin, and 5 parts of binder;
S2. Preliminary mixing of raw materials: Mix the bamboo extract, the soybean residue powder, the sweet potato residue powder, and the pine sawdust evenly to obtain a first mixed powder;
S3. Grinding: Place the bentonite, the diatomaceous earth, the volcanic rock particles, and the perlite powder into a ball mill to perform grinding and mixing to obtain a second mixed powder;
S4. Solution preparation: Mix anthocyanin with water thoroughly to form a mixed solution;
S5. Secondary mixing: thoroughly mix the first mixed powder with the mixed solution and add a binder at the same time, then add the second mixed powder for thorough mixing, and add the binder to prepare a pasty mass;
S6. Granulation: put the pasty mass into a granulator for granulation, forming mixed particles;
S7. Drying: dry the mixed particles, and then cool the dried mixed particles to obtain the finished cat litter product.

Preferably, in this embodiment, the method for preparing the bamboo extract includes:
S101. Clean bamboo branches, then dry the bamboo branches, and then crush them with a grinder to obtain crushed bamboo material;
S102. Soak the crushed bamboo material in NaOH solution for 2 hours. After soaking is complete, add an acid solution to adjust the pH value to obtain a bamboo aqueous solution. The pH value of the bamboo aqueous solution is 6.2;
S103. Add ethyl acetate and ether to the bamboo aqueous solution, and use distillation process to obtain the bamboo extract.

In this embodiment, it is preferred that the method for preparing soybean residue powder includes:
S201. Take the soybean residue and wash it multiple times, then place the washed soybean residue in a dryer for drying;
S202. Place the dried soybean residue in a crushing device and crush it, then sieve the crushed soybean residue to obtain primary soybean residue powder;
S203. Add an appropriate amount of distilled water to the primary soybean residue powder to wet it, then adjust the pH value, and send the primary soybean residue powder after PH adjustment to the dryer for further drying to obtain the finished soybean residue powder.

In this embodiment, it is preferred that the drying temperature of the dryer in S203 is 140° C., the drying time is 40 minutes, and the moisture content in the soybean residue powder is dried to 8%. The crushed soybean residue in S202 is sieved through an 80 mesh sieve.

In this embodiment, it is preferred that the preparation method of the sweet potato residue powder is the same as that of the soybean residue powder.

In this embodiment, it is preferred that the diameter of particles of the cat litter is 4 mm and the length of particles of the cat litter is 0.8 cm.

### Embodiment 4

Please refer to the FIGURE. The present disclosure provides a technical solution: a cat litter including the following raw material compositions in weight parts: 45 parts of bamboo extract, 12 parts of soybean residue powder, 6 parts of sweet potato residue powder, 5 parts of pine sawdust, 35 parts of bentonite, 6 parts of diatomaceous earth, 6 parts of volcanic rock particles, 5 parts of perlite powder, 0.7 parts of anthocyanin, and 5 parts of binder.

In this embodiment, it is preferred that the adhesive includes guar gum, locust bean gum, and sodium carboxymethyl starch.

A method for preparing cat litter, including the following steps:
S1. Raw material preparation: Prepare raw materials according to the following weight parts: 45 parts of bamboo extract, 12 parts of soybean residue powder, 6 parts of sweet potato residue powder, 5 parts of pine sawdust, 35 parts of bentonite, 6 parts of diatomaceous earth, 6 parts of volcanic rock particles, 5 parts of perlite powder, 0.7 parts of anthocyanin, and 5 parts of binder;
S2. Preliminary mixing of raw materials: Mix the bamboo extract, the soybean residue powder, the sweet potato residue powder, and the pine sawdust evenly to obtain a first mixed powder;
S3. Grinding: Place the bentonite, the diatomaceous earth, the volcanic rock particles, and the perlite powder into a ball mill to perform grinding and mixing to obtain a second mixed powder;
S4. Solution preparation: Mix anthocyanin with water thoroughly to form a mixed solution;
S5. Secondary mixing: thoroughly mix the first mixed powder with the mixed solution and add a binder at the same time, then add the second mixed powder for thorough mixing, and add the binder to prepare a pasty mass;
S6. Granulation: put the pasty mass into a granulator for granulation, forming mixed particles;
S7. Drying: dry the mixed particles, and then cool the dried mixed particles to obtain the finished cat litter product.

Preferably, in this embodiment, the method for preparing the bamboo extract includes:
S101. Clean bamboo branches, then dry the bamboo branches, and then crush them with a grinder to obtain crushed bamboo material;
S102. Soak the crushed bamboo material in NaOH solution for 2 hours. After soaking is complete, add an acid solution to adjust the pH value to obtain a bamboo aqueous solution. The pH value of the bamboo aqueous solution is 5.8;
S103. Add ethyl acetate and ether to the bamboo aqueous solution, and use distillation process to obtain the bamboo extract.

In this embodiment, it is preferred that the method for preparing soybean residue powder includes:
S201. Take the soybean residue and wash it multiple times, then place the washed soybean residue in a dryer for drying;
S202. Place the dried soybean residue in a crushing device and crush it, then sieve the crushed soybean residue to obtain primary soybean residue powder;
S203. Add an appropriate amount of distilled water to the primary soybean residue powder to wet it, then adjust the pH value, and send the primary soybean residue powder after PH adjustment to the dryer for further drying to obtain the finished soybean residue powder.

In this embodiment, it is preferred that the drying temperature of the dryer in S203 is 130° C., the drying time is 40 minutes, and the moisture content in the soybean residue powder is dried to 7%. The crushed soybean residue in S202 is sieved through a 75 mesh sieve.

In this embodiment, it is preferred that the preparation method of the sweet potato residue powder is the same as that of the soybean residue powder.

In this embodiment, it is preferred that the diameter of particles of the cat litter is 3.5 mm and the length of particles of the cat litter is 0.5 cm.

Principles and advantages of the present disclosure:

The present disclosure adds bamboo extract to make the raw materials green and healthy, increasing safety of use. At the same time, adding soybean residue powder, sweet potato residue powder, and pine sawdust can not only reduce material costs, but also increase softness and strong water absorption. When discarded, it can be directly buried in the ground as soil nutrients, which is environmentally friendly and biodegradable, safe and pollution-free, with renewable raw materials, thereby increasing resource utilization efficiency. The cat litter in the present disclosure is made by mixing anthocyanins with other raw materials in proportion, granulation, and drying. By adding anthocyanins, the anthocyanins can change color in response to the different pH levels of pet excrement, thereby determining whether the pet is healthy. For example, when a pet consumes excessive amounts of meat, its excrement becomes acidic, and the anthocyanin color changes to red; when a pet consumes excessive amounts of vegetables, its excrement becomes alkaline, and the anthocyanin color changes to green, in severe cases, it may turn yellow; under normal conditions, the anthocyanin does not change color. This phenomenon enables real-time monitoring of the cat excrement pH, allowing pet owners to promptly understand the health status of their cat. In addition, first anthocyanins are mixed with materials such as pine sawdust, and then mixing them into bentonite, diatomaceous earth, volcanic rock particles, and perlite powder. In this way, due to volcanic rock particles have fine pores, the anthocyanin material mixed with pine sawdust can be filled into the pores of volcanic rock, effectively protecting anthocyanins from the influence of acidic and alkaline substances in the air and extending their service life. The addition of diatomaceous earth to the raw materials of the present disclosure can enhance the odor adsorption capacity of cat litter, effectively improving its deodorizing performance. By adding volcanic rock particles and utilizing their resistance to mold, the cat litter can inhibit the growth of mold in humid environments and has high antibacterial properties. In addition, volcanic rock particles also have high thermal insulation effects, thereby improving the quality of cat litter use.

The cat litters made by traditional process and the present disclosure were selected for the following experiments. The experimental content and results are shown in the table below.

| | | | | Thermal |
|---|---|---|---|---|
| | Water | Deodorizing | Antibacterial | insulation |
| | absorption | property | property | property |
| Traditional cat | 90% | 80% | 91% | 82% |
| litter | | | | |
| Embodiment 1 | 95% | 92% | 94% | 86% |
| Embodiment 2 | 92% | 93% | 92% | 89% |
| Embodiment 3 | 97% | 98% | 96% | 92% |
| Embodiment 4 | 96% | 96% | 90% | 90% |

Through various experiments, it can be found that the water absorption, deodorization, antibacterial, and thermal insulation properties of the cat litter prepared in embodiments 1, 2, 3, and 4 have been improved, and embodiment 3 is the best embodiment.

Although the embodiments of the present disclosure have been shown and described, it will be understood by those skilled in the art that various changes, modifications, substitutions, and variations can be made to these embodiments without departing from the principles and spirit of the present disclosure. The scope of the present disclosure is limited by the appended claims and their equivalents.

What is claimed is:

1. A cat litter, comprising following raw material compositions in weight parts: 40-60 parts of bamboo extract, 10-20 parts of soybean residue powder, 5-10 parts of sweet potato residue powder, 4-8 parts of pine sawdust, 30-50 parts of bentonite, 5-8 parts of diatomaceous earth, 5-8 parts of volcanic rock particles, 4-6 parts of perlite powder, 0.5-1.5 parts of anthocyanin, and 4-6 parts of binder.

2. The cat litter according to claim 1, comprising following raw material compositions in weight parts: 50 parts of the bamboo extract, 15 parts of the soybean residue powder, 8 parts of the sweet potato residue powder, 6 parts of the pine sawdust, 40 parts of the bentonite, 7 parts of the diatomaceous earth, 7 parts of the volcanic rock particles, 5 parts of the perlite powder, 1 part of the anthocyanin, and 5 parts of the binder.

3. The cat litter according to claim 1, wherein the binder comprises one or more of guar gum, locust bean gum, and sodium carboxymethyl starch.

4. A method for preparing a cat litter, comprising following steps:
S1, raw material preparation: preparing raw materials according to the following weight parts: 40-60 parts of bamboo extract, 10-20 parts of soybean residue powder, 5-10 parts of sweet potato residue powder, 4-8 parts of pine sawdust, 30-50 parts of bentonite, 5-8 parts of diatomaceous earth, 5-8 parts of volcanic rock particles, 4-6 parts of perlite powder, 0.5-1.5 parts of anthocyanin, and 4-6 parts of binder;
S2, preliminary mixing of raw materials: mixing the bamboo extract, the soybean residue powder, the sweet potato residue powder, and the pine sawdust evenly to obtain a first mixed powder;
S3, grinding: placing the bentonite, the diatomaceous earth, the volcanic rock particles, and the perlite powder into a ball mill, then grinding and mixing to obtain a second mixed powder;
S4, solution preparation: mixing the anthocyanin with water thoroughly to form a mixed solution;
S5, secondary mixing: thoroughly mixing the first mixed powder with the mixed solution and adding the binder at the same time, then adding the second mixed powder for thorough mixing, and adding the binder to prepare a pasty mass;
S6, granulation: putting the pasty mass into a granulator to perform granulation to form mixed particles;
S7, drying: drying the mixed particles, and then cooling the mixed particles after drying to obtain a finished cat litter product.

5. The method for preparing the cat litter according to claim 4, wherein a method for preparing the bamboo extract comprises:
S101, cleaning bamboo branches, then drying the bamboo branches, and then crush the bamboo branches after drying with a grinder to obtain crushed bamboo material;
S102, soaking the crushed bamboo material in NaOH solution for 1-3 hour, after soaking is complete, adding an acid solution to adjust a pH value to obtain a bamboo aqueous solution, wherein the pH value of the bamboo aqueous solution is 5.6-6.6;
S103, adding ethyl acetate and ether to the bamboo aqueous solution, and applying distillation process to obtain the bamboo extract.

6. The method for preparing the cat litter according to claim 4, wherein a method for preparing the soybean residue powder comprises:
S201, taking soybean residue and wash the soybean residue for multiple times, then placing the soybean residue after washing in a dryer to perform drying;
S202, placing the soybean residue after drying in a crushing device to crush, then sieving the soybean residue after crushing to obtain primary soybean residue powder;
S203, adding an appropriate amount of distilled water to the primary soybean residue powder for wetting, then adjusting the pH value, and then sending the primary soybean residue powder after PH adjustment to the dryer for further drying to obtain a finished soybean residue powder.

7. The method for preparing the cat litter according to claim 6, wherein a drying temperature of the dryer in S203 is 120° C.-160° C., a drying time is 30-60 minutes, and a moisture content in the soybean residue powder is dried to 6-10%, wherein the soybean residue after crushing in S202 is sieved through a 70-90 mesh sieve.

8. The method for preparing the cat litter according to claim 7, wherein a preparation method of the sweet potato residue powder is the same as that of the soybean residue powder.

9. The method for preparing the cat litter according to claim 4, wherein a diameter of the particles of the cat litter is 3-5 mm, and a length of the particles of the cat litter is 0.4-1.2 cm.
